(19) United States
(12) Patent Application Publication
(10) Pub. No.: US 2011/0049076 A1
(43) Pub. Date: Mar. 3, 2011

(54) Method and Apparatus for Vertically Orienting Precast Concrete Wall Panels

(76) Inventors: Richard F. Wehrli, Naperville, IL (US); Joseph Gallione, Naperville, IL (US)

(21) Appl. No.: 12/874,805

(22) Filed: Sep. 2, 2010

Related U.S. Application Data
(60) Provisional application No. 61/239,141, filed on Sep. 2, 2009.
(60) Provisional application No. 61/239,063, filed on Sep. 2, 2009.

(51) Int. Cl. B66C 1/66; B66C 17/00; B66C 13/00

(52) U.S. Cl. 212/283; 294/119.1; 212/84; 212/270

(57) ABSTRACT

An apparatus orients to a vertical position a precast wall panel formed in a horizontal position. The panel has holes formed in opposite sides thereof. The apparatus includes an overhead crane having a pair of suspended hooks and a lifting beam assembly suspended from the crane hooks. The lifting beam assembly includes a pair of oppositely facing pin carriages each having a pin adapted to be received in one of the panel holes. The lifting beam assembly further includes a motorized drive mechanism for displacing the pin carriages toward and away from each other along the length of the lifting beam. Displacing the pin carriages toward each other along the length of the lifting beam allows the pins to align with and engage the panel holes. Raising the crane hooks orients the wall panel in a vertical position.

### CROSS-REFERENCE TO RELATED APPLICATIONS/INCORPORATION BY REFERENCE

This application claims priority benefits from U.S. Provisional Patent Application Ser. No. 61/239,141 filed Sep. 2, 2009, entitled “Method And Apparatus For Vertically Orienting Precast Concrete Wall Panels”. This application also claims priority benefits from U.S. Provisional Patent Application Ser. No. 61/239,063 filed Sep. 2, 2009, entitled “Tilting Table With Telescoping Arms For Precast Vertical Wall Panels”. The '141 and '063 provisional applications are hereby incorporated by reference herein in their entirety.

### FIELD OF THE INVENTION

The present invention relates to precast building wall panels. In particular, the present invention relates to a technique for lifting precast building wall panels formed in a horizontal position into a vertical position for subsequent storage and transporting.

### BACKGROUND OF THE INVENTION

In the manufacture of precast building wall panels, it is particularly problematic to orient the heavy panels, which are formed by casting in a horizontal position, to a vertical position in which they can be conveniently stored and transported. The present technique overcomes the problem using a lifting beam with a pair of pin drive assemblies for engaging holes formed in opposite sides of the wall panel.

The advantages of handling, storing and shipping wall panels in a vertical position include:
(a) road transportation permits are not required for panels wider than 8.5 feet;
(b) panels up to 12 feet wide can be shipped vertically with no dimensional travel restrictions;
(c) panels can stacked and stored more densely in a vertical position than in a horizontal position;
(d) special horizontal wall panel lifters are not required.

The present lifting beam apparatus can be used to lift concrete panels directly, or it can also be attached to a vacuum lifting beam. When panels are cast horizontally, the vacuum beam can be employed to lift the panel off the casting frame and place it on a hydraulic tilting table. The tilting table can tilt the panel to a near-vertical position (up to about 80° from horizontal), where the panel can then be lifted vertically by the lifting beam.

### SUMMARY OF THE INVENTION

Embodiments of the present technology provide methods and systems for orienting to a vertical position a precast wall panel formed in a horizontal position, the panel having holes formed in opposite sides thereof.

In an embodiment, a lifting beam assembly includes: (a) a lifting beam; (b) a pair of oppositely facing pin carriages mounted on said lifting beam, each of said pin carriages comprising a pin adapted to be received in a hole formed in opposing sides of a precast wall panel formed in a horizontal position; and (c) a motorized drive mechanism configured to displace said pin carriages toward and away from each other along the length of said lifting beam.

In an embodiment, the lifting beam is configured to be lifted by an overhead crane using a pair of hooks.

In an embodiment, the motorized drive mechanism is operatively connected to a drive shaft that is operatively connected to a pair of ball screws, each ball screw associated with one of the pin carriages in order to displace the associated pin carriage.

In an embodiment, rotation of the drive shaft in a first direction causes the pin carriages to move away from each other, and wherein rotation of the drive shaft in a second direction opposite the first direction causes the pin carriages to move toward each other.

In an embodiment, the lifting beam further includes a load cell pin configured to detect a weight of the lifting beam assembly and any item affixed thereto.

In an embodiment, the lifting beam further includes a scale display configured to display the weight detected by the load cell.

In an embodiment, the pin carriages remain equidistant from a center of the lifting beam when the pin carriages are displaced.

In an embodiment, a system for orienting to a vertical position a precast wall panel formed in a horizontal position, the panel having holes formed in opposite sides thereof, includes: (a) an overhead crane having a pair of suspended hooks; (b) a lifting beam suspended from said crane hooks, said lifting beam comprising: (i) a pair of oppositely facing pin carriages mounted on said lifting beam, each of said pin carriages comprising a pin adapted to be received in one of said panel holes; (ii) a motorized drive mechanism for displacing said pin carriages toward and away from each other along the length of said lifting beam.

In an embodiment, the motorized drive mechanism is operatively connected to a drive shaft that is operatively connected to a pair of ball screws, each ball screw associated with one of the pin carriages in order to displace the associated pin carriage.

In an embodiment, rotation of the drive shaft in a first direction causes the pin carriages to move away from each other, and wherein rotation of the drive shaft in a second direction opposite the first direction causes the pin carriages to move toward each other.

In an embodiment, the system further includes a load cell pin configured to detect a weight of the lifting beam assembly and any item affixed thereto.

In an embodiment, the system further includes a scale display configured to display the weight detected by the load cell.

In an embodiment, the pin carriages remain equidistant from a center of the lifting beam when the pin carriages are displaced.

In an embodiment, the system further includes vacuum lifting beam configured to use suction to lift a horizontally disposed wall panel.

In an embodiment, a method of orienting to a vertical position a precast wall panel formed in a horizontal position includes: aligning pins extending from a pair of oppositely facing pin carriages on a lifting beam with holes formed in opposite sides of a precast wall panel formed in a horizontal position; displacing the pin carriages toward each other along the length of said lifting beam such that said pins engage said holes; and rising the lifting beam, thereby orienting said wall panel in a vertical position.

In an embodiment, hooks suspended from an overhead crane are used to align the pins and raise the lifting beam.

In an embodiment, the method further includes using a vacuum lifting beam to lift the wall panel in a horizontal orientation and place the wall panel on a tilting table in the horizontal orientation.

In an embodiment, the method further includes using the tilting table to rotate the wall panel from the horizontal orientation to a near vertical orientation.

In an embodiment, the method further includes placing the vertically oriented wall panel in a trailer configured to transport vertically oriented wall panels.

In an embodiment, the method further includes continuously measuring and displaying a weight of the lifting beam and the wall panel.

### DESCRIPTION OF THE DRAWINGS

FIG. 1 is a front elevation view of a lifting beam assembly used in accordance with embodiments of the present technology.

FIG. 2 is a top-sectional view of the lifting beam assembly of FIG. 1.

FIG. 3 is a side elevation view of the lifting beam assembly of FIG. 1.

FIG. 4 is a side sectional view of the lifting beam assembly of FIG. 1 taken in the direction of arrows 4-4.

FIG. 5 is an exploded view of the right-hand ball screw assembly for displacing the right-hand pin carriage along the length of the lifting beam assembly of FIG. 1.

FIG. 6 is an exploded view of the left hand pin carriage in the lifting beam assembly illustrated in FIG. 1.

FIG. 7 is a magnified view of the torque bracket assembly in the lifting beam assembly of FIG. 1.

FIG. 8 is a magnified view of the motor assembly in the lifting beam assembly of FIG. 1.

FIG. 9 is a magnified view of the bearing assembly in the lifting beam assembly of FIG. 1.

FIG. 10 depicts an apparatus for orienting to a vertical position a precast wall panel formed in a horizontal position in accordance with embodiments of the present technology. The apparatus includes an overhead crane and the lifting beam assembly of FIG. 1.

FIG. 11 is a side elevation view of the apparatus of FIG. 10 depositing a vertically-oriented building wall panel into a trailer for transporting multiple wall panels oriented in a vertical position.

FIG. 12 is a rear elevation view of the apparatus of FIG. 10 depositing a vertically-oriented building wall panel into a trailer for transporting multiple wall panels oriented in a vertical position.

FIG. 13 is a front elevation view of the apparatus of FIG. 10 from which a vacuum lifting beam is suspended.

FIG. 14 is a side elevation view of a precast wall panel on a hydraulic tilting table in the horizontal position.

FIG. 15 is a side elevation view of a precast wall panel on a hydraulic tilting table in a near-vertical position.

FIG. 16 is a perspective view of a precast wall panel on a hydraulic tilting table in a near-vertical position.

FIG. 17 is a perspective view of the apparatus of FIG. 10 being aligned so that the pins projecting from the pin carriage can be inserted into and engage the holes formed in a precast wall panel mounted in a tilting table holding the wall panel in a near-vertical position.

FIG. 18 is a perspective view of the apparatus of FIG. 10 being used to transport a precast wall panel after the wall panel has been lifted from a tilting table into a vertical position.

### DETAILED DESCRIPTION OF PREFERRED EMBODIMENT(S)

The present invention relates to precast building wall panels. In particular, the present invention relates to a technique for lifting precast building wall panels formed in a horizontal position into a vertical position for subsequent storage and transporting. Certain embodiments employ a lifting beam assembly with opposing pin carriages configured to be movable about the length of a beam. The pin carriages each comprise a pin, such that the opposing pins can be inserted into holes on opposite sides of a wall panel in order to lift the panel such that the panel can be transported and/or stored in a vertical position. Certain embodiments are described below in connection with the figures. In the figures, like elements have like identifiers.

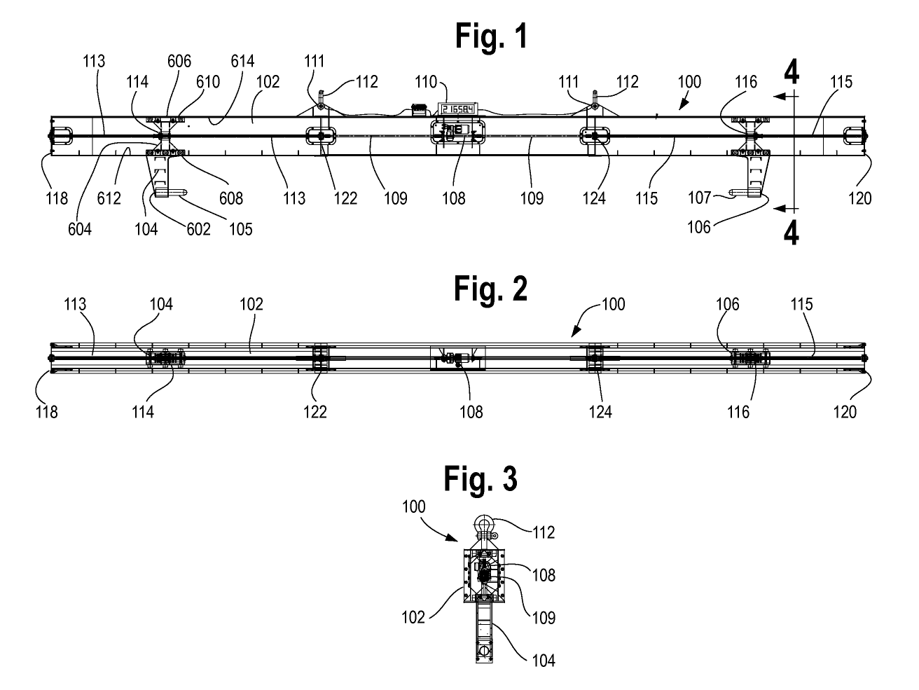

FIG. 1 is front elevation view of a lifting beam assembly 100 used in accordance with embodiments of the present technology. Lifting beam assembly 100 includes beam 102, left hand pin carriage 104 comprising pin 105, right hand pin carriage 106 comprising pin 107, motorized drive mechanism 108, drive shaft 109, scale display 110, load cell pins 111, shackles 112, left hand ball screw 113, left hand ball screw bearing 114, right hand ball screw 115, and right hand ball screw bearing 116.

Shackles 112 are attached to the top of beam 102 in spaced apart relation. In certain embodiments, right and left shackles 112 are spaced apart about 15 feet, each shackle 112 being 7.5 feet from the center of beam 102. Shackles 112 are configured to receive respective hooks of an overhead crane. Shackles 112 are attached to the top of beam 102 at load cell pins 111. Load cell pins 111 are configured to detect the weight of the lifting beam assembly 100 and any item(s) being lifted by lifting beam assembly 100. Scale display 110 is in operable communication with load cell pins 111 and is configured to display the weight detected by load cell pins 111. Load cell pins 111 and scale display 110 can be used to help prevent overloading an overhead crane.

Motorized drive mechanism 108 is disposed inside beam 102 and positioned at the center of beam 102. Motorized drive mechanism 108 is operably connected to drive shaft 109 such that activating motorized drive mechanism 108 can cause drive shaft 109 to rotate in a first direct and a second direction opposite the first direction. Drive shaft 109 is disposed inside beam 102 and is operably connected to left hand ball screw 113 and right hand ball screw 115 such that ball screws 113, 115 rotate when drive shaft 109 rotates. Left hand ball screw 113 is disposed inside beam 102 and is operably connected to left hand ball screw bearing 114 such that left hand ball screw bearing 114 translates horizontally about left hand ball screw 113 when left hand ball screw 113 rotates, thereby causing left hand pin carriage 104 and pin 105 to translate horizontally about the length of beam 102. Right hand ball screw 115 is disposed inside beam 102 and is operably connected to right hand ball screw bearing 116 such that right hand ball screw bearing 116 translates horizontally about right hand ball screw 115 when right hand ball screw 115 rotates, thereby causing right hand pin carriage 106 and pin 107 to translate horizontally about the length of beam 102.

In operation, motorized drive mechanism 108 can be activated, causing drive shaft 109 to rotate in a first direction such that pins 105 and 107 move toward the center of beam 102. That is, when drive shaft 109 rotates in the first direction, left hand ball screw 113 rotates in the first direction forcing left hand ball screw bearing 114 to translate horizontally about left hand ball screw 113 toward the center of beam 102. This causes left hand pin carriage 104 and pin 105 to move toward the center of beam 102. Likewise, when drive shaft 109 rotates in the first direction, right hand ball screw 115 rotates in the first direction forcing right hand ball screw bearing 116 to translate horizontally about right hand ball screw 115 toward the center of beam 102. This causes right hand pin carriage 106 and pin 107 to move toward the center of beam 102.

Motorized drive mechanism 108 can also be operated in reverse, causing drive shaft 109 to rotate in a second direction opposite the first direction such that pins 105 and 107 move away from the center of beam 102 toward the ends 118, 120 of beam 102. That is, when drive shaft 109 rotates in the second direction, left hand ball screw 113 rotates in the second direction forcing left hand ball screw bearing 114 to translate horizontally about left hand ball screw 113 away from the center of beam 102 toward the left end 118 of beam 102. This causes left hand pin carriage 104 and pin 105 to move away from the center of beam 102 toward the left end 118 of beam 102. Likewise, when drive shaft 109 rotates in the second direction, right hand ball screw 115 rotates in the second direction forcing right hand ball screw bearing 116 to translate horizontally about right hand ball screw 115 away from the center of beam 102 toward the right end 120 of beam 102. This causes right hand pin carriage 106 and pin 107 to move away from the center of beam 102 toward the right end 120 of beam 102.

In the embodiment depicted in FIG. 1, left hand ball screw bearing 114 can translate horizontally about left hand ball screw 113 between the left end 118 of beam 102 and a point 122 where left hand ball screw 113 is attached to drive shaft 109. In certain embodiments, point 122 is positioned at the same place on beam 102 that the left shackle is positioned. Similarly, right hand ball screw bearing 116 can translate horizontally about right hand ball screw 115 between the right end 120 of beam 102 and a point 124 where right hand ball screw 115 is attached to drive shaft 109. In certain embodiments, point 124 is positioned at the same place on beam 102 that the right shackle is positioned. In certain embodiments, left hand ball screw bearing 114 and right hand ball screw bearing 116 are maintained at equal distances from the center of beam 102 in order to maintain balance of lifting beam assembly 100 and any item(s) being transported using lifting beam assembly 100. In certain embodiments, beam 102 can span about 44 feet and 7 inches. In certain embodiments, the maximum distance between pins 105, 107 is about 40 feet. In certain embodiments, the minimum distance between pins 105, 107 is about 14 feet and 10 inches. In certain embodiments, the maximum distance that each pin carriage 104, 106 can move laterally about the length of beam 102 is about twelve feet and 7 inches.

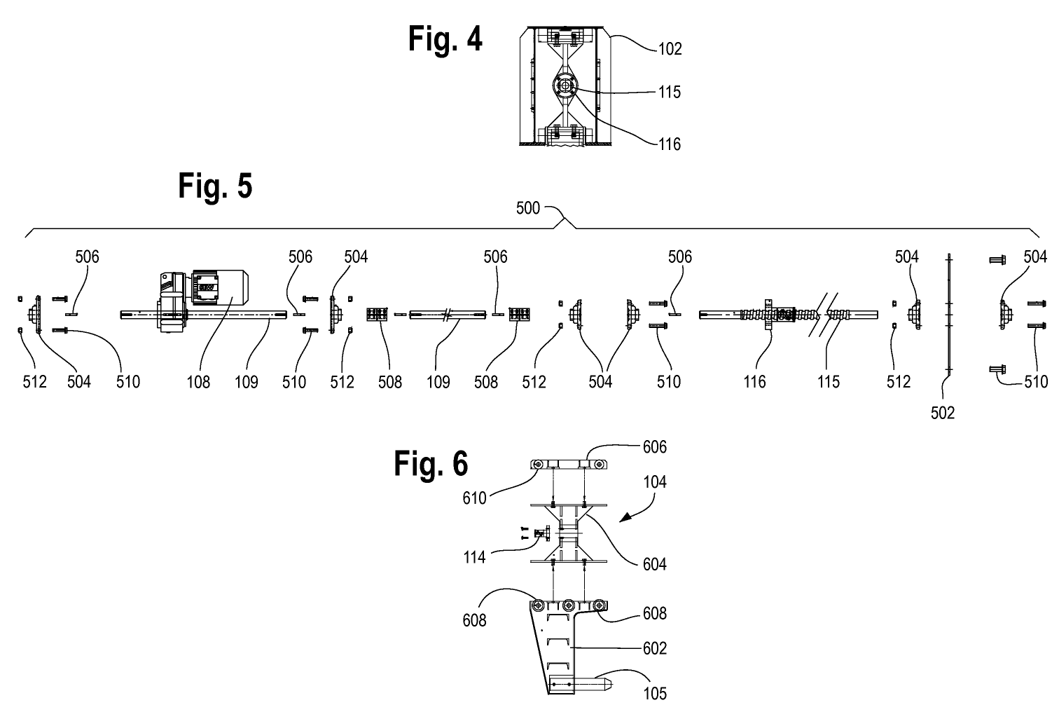

FIG. 2 is a top-sectional view of the lifting beam assembly 100. FIG. 3 is a side elevation view of the lifting beam assembly 100. FIG. 4 is a side sectional view of the lifting beam assembly 100 taken in the direction of arrows 4-4 (see FIG. 1).

FIG. 5 is an exploded view of right-hand ball screw assembly 500 for displacing right-hand pin carriage 105 along the length of beam 102. The left-hand ball screw assembly for displacing left-hand pin carriage 104 mirrors the illustrated right-hand ball screw assembly 500, using the same motorized drive mechanism 108. Right-hand ball screw assembly 500 includes motorized drive mechanism 108, drive shaft 109, right hand ball screw 115, right hand ball screw bearing 116, and endplate 502. Drive shaft 109 includes two portions connected at bolt flange bearing 504 with keystocks 506 at rigid coupling 508. Bolts/washers 510 and hex nuts 512 are used to attach bolt flange bearing 504 to rigid coupling 508. Similar, items are used to connect right hand ball screw 115 to drive shaft 109. Similar, items are also used to connect endplate 502.

FIG. 6 is an exploded view of left hand pin carriage 104 from lifting beam assembly 100. Right hand pin carriage 106 mirrors the left hand pin carriage 104. Left hand pin carriage 104 includes pin bracket 602 with rollers 608, pin 105, left hand ball screw bearing 114, ball screw bracket 604, and ball screw guide 606 with rollers 610. Ball screw bracket 604 is configured to receive left hand ball screw bearing 114 and maintain left hand ball screw bearing 114 therein. Ball screw bracket 604 is rigidly attached to pin bracket 602 at its bottom and ball screw guide 606 at its top. Pin bracket 602 includes rollers 608 configured to contact a lower interior surface 612 (depicted in FIG. 1) of beam 102 in order to facilitate lateral displacement of pin carriage 104 about the length of beam 102. Ball screw guide 606 includes rollers 610 configured to contact an upper interior surface 614 (depicted in FIG. 1) of beam 102 in order to facilitate lateral displacement of pin carriage 104 about the length of beam 102.

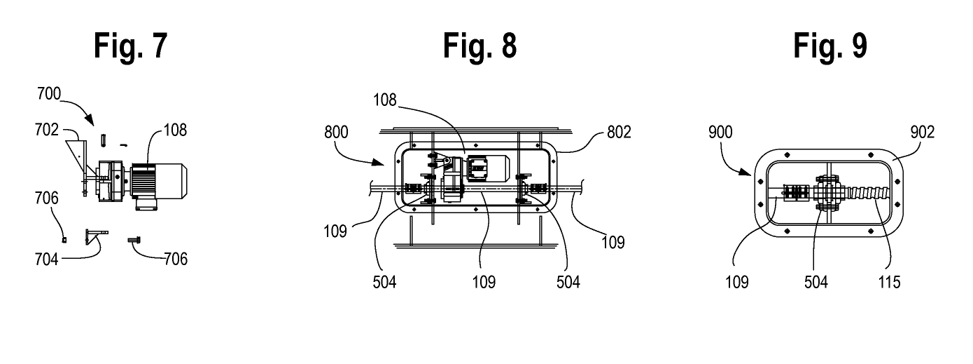

FIG. 7 is a magnified view of the torque bracket assembly 700 in the lifting beam assembly 100. Torque bracket assembly 700 is configured to mount motorized drive mechanism 108 to the upper interior surface 614 of beam 102, and includes mounting beam 702, bar mount 704 and mounting screw/nut 706. In certain embodiments, torque bracket assembly 700 can be used to mount motorized drive mechanism 108 at or near the center of beam 102.

FIG. 8 is a magnified view of the motor assembly 800 in the lifting beam assembly 100. Motor assembly 800 is disposed inside beam 102, and can be provided behind window 802, which can allow motor assembly 800 to be viewed from outside beam 102. Window 802 can also be opened or removed in order to provide access to motor assembly 800. Motor assembly 800 includes motorized drive mechanism 108, drive shafts 109 and bolt flange bearings 504, as also depicted and described in connection with FIG. 5.

FIG. 9 is a magnified view of the right hand bearing assembly 900 in the lifting beam assembly 100. Bearing assembly 900 is disposed inside beam 102, and can be provided behind window 902, which can allow bearing assembly 900 to be viewed from outside beam 102. Window 902 can also be opened or removed in order to provide access to bearing assembly 900. Bearing assembly 900 includes drive shaft 109, bolt flange bearings 504, and right hand ball screw 115, as also depicted and described in connection with FIG. 5.

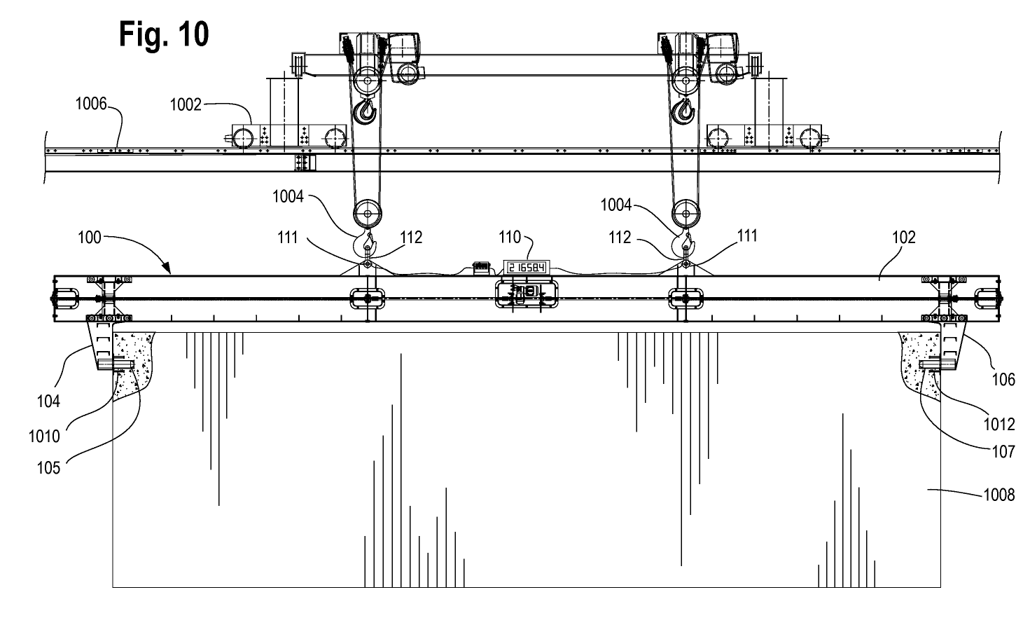

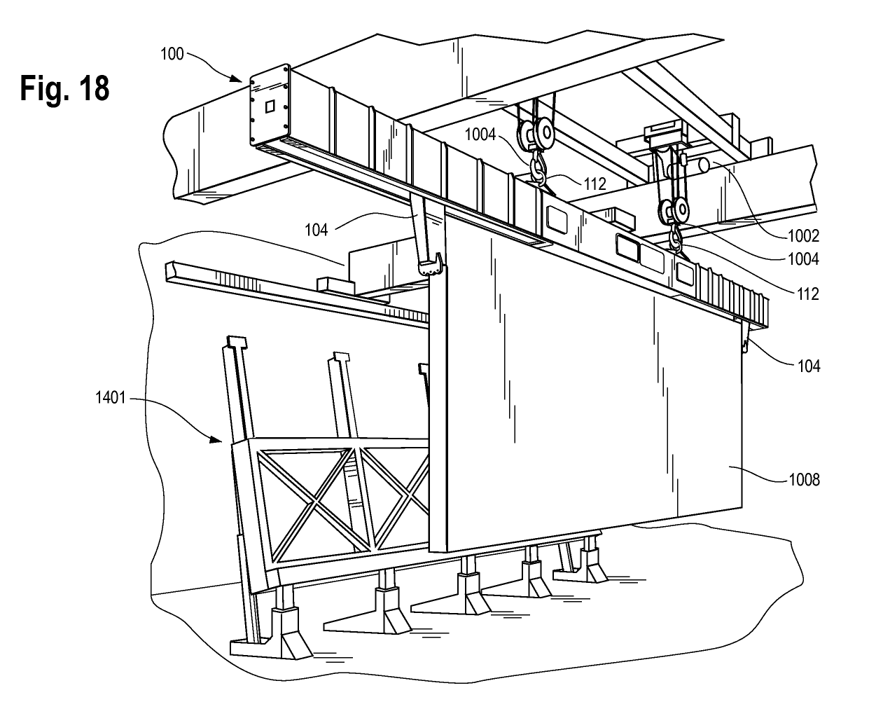

FIGS. 10-18 depict lifting beam assembly 100 being used in connection with an overhead crane 1002, a vacuum lifting beam 1302 and/or a tilting table 1401 in order to transport horizontally precast wall panels in a vertical orientation.

FIG. 10 depicts an apparatus for orienting to a vertical position a precast wall panel 1008 formed in a horizontal position in accordance with embodiments of the present technology. The apparatus includes overhead crane 1002 and lifting beam assembly 100. Crane 1002 is configured to be supported by, and movable about, an overhead support system 1006. Overhead crane 1002 includes hooks 1004 suspended from crane 1002. Hooks 1004 are received by shackles 112 of lifting beam assembly 100 such that crane 1002 can be used to lift and transport lifting beam assembly 100 and any item(s) affixed thereto. Lifting beam assembly 100 can be affixed to precast wall panel 1008 by inserting pins 105, 107 into holes 1010, 1012 located on opposing sides of precast wall panel 1008. The location of holes 1010, 1012 on opposing sides and toward an end of wall panel 1008 cause wall panel 1008 to become vertically oriented when lifted by pins 105, 107. That is, wall panel 1008 will rotate on pins 105, 107 to a vertical orientation when lifted by pins 105, 107.

As depicted in FIG. 10, crane 1002 can include two hooks 1004 and lifting beam assembly 100 can include two shackles 112 in spaced apart relation. In other embodiments, crane 1002 can include more hooks 1004 and lifting beam assembly 100 can include a corresponding number of shackles 112 in spaced apart relation. In certain embodiments, crane 1002 can have a capacity of about 60,000 pounds. In certain embodiments, lifting beam assembly 100 can weigh about 6200 pounds.

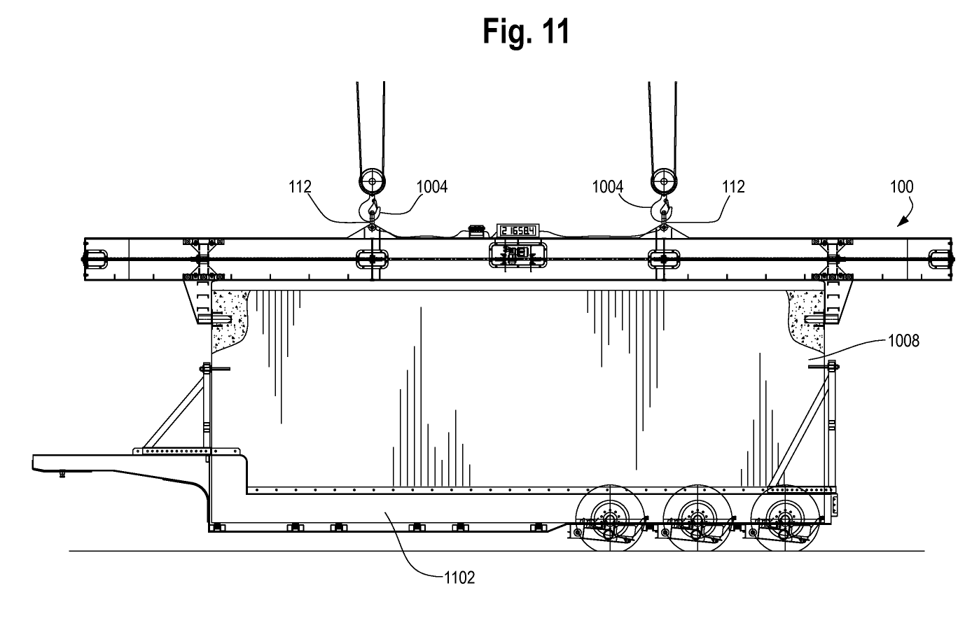

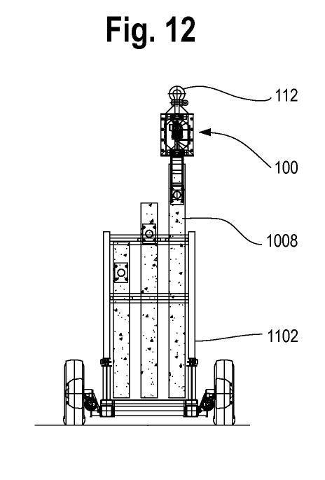

As depicted in FIGS. 11-12, crane 1002 and lifting beam assembly 100 can be used to deposit a vertically-oriented building wall panel 1008 into a trailer 1102 configured to transport wall panels oriented in a vertical position.

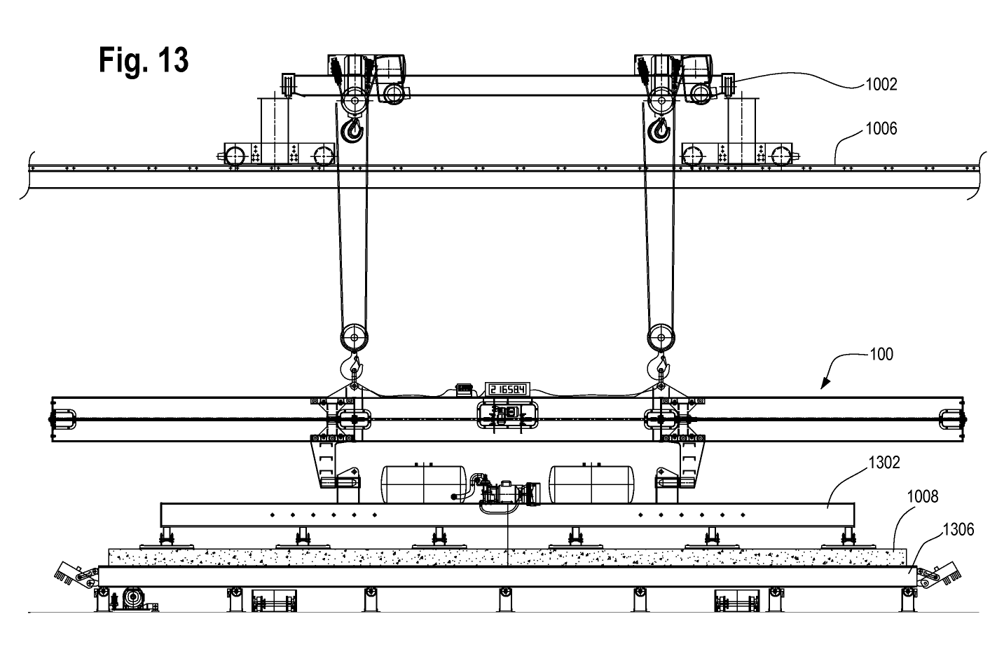

As depicted in FIG. 13, lifting beam assembly 100 can be affixed to a vacuum lifting beam 1302 configured to use vacuum suction to lift a horizontally disposed wall panel 1008 from a casting frame 1306. Wall panel 1008 can then be transported in the horizontal position to a tilting table, where vacuum suction can be discontinued such that wall panel 1008 rests on the tilting table. In certain embodiments, vacuum lifting beam 1302 can weigh about 4800 pounds.

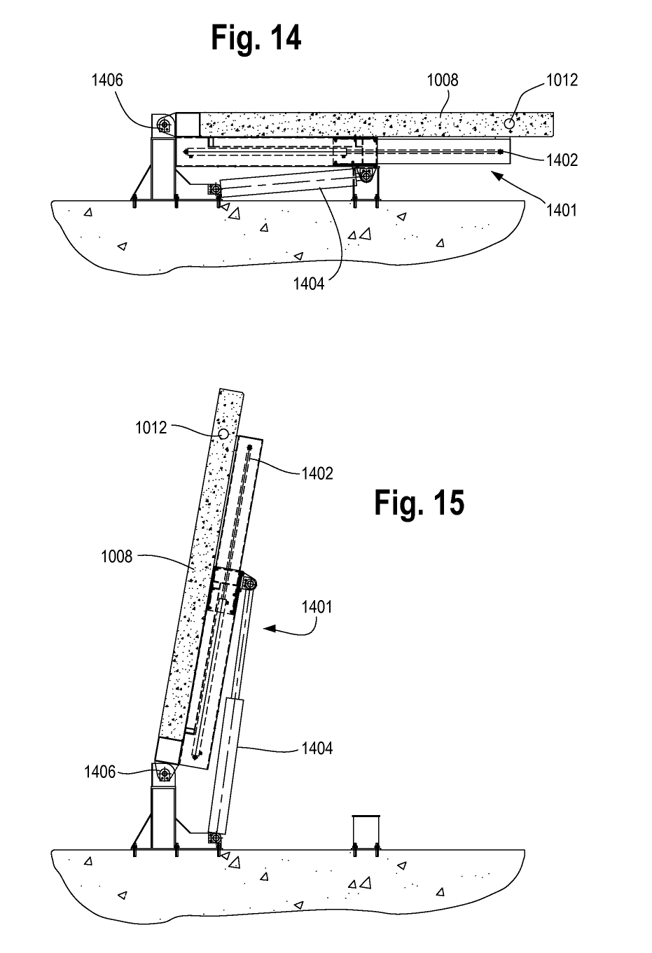

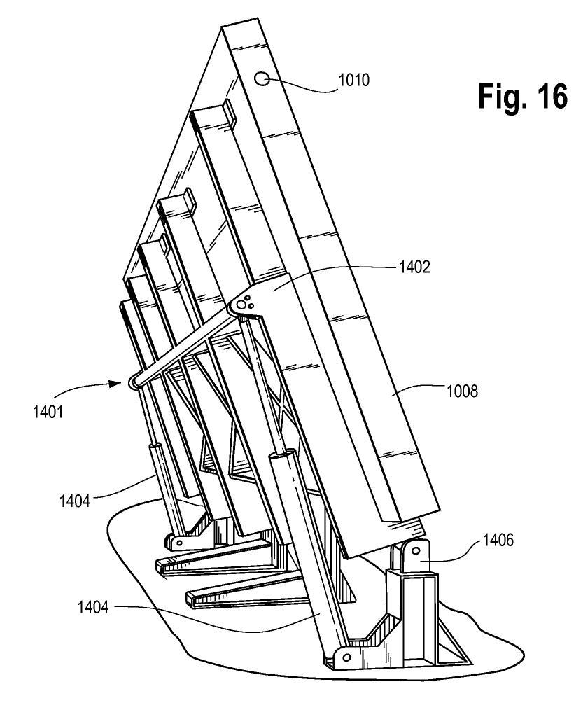

FIG. 14 depicts wall panel 1008 disposed horizontally on tilting table 1401. Tilting table 1401 includes telescoping table 1402, hydraulic arm 1404 and pivot 1406. Telescoping table 1402 can be extended to accommodate a wall panel with a greater surface area and retracted to accommodate a wall panel with less surface area. Telescoping table 1402 can be rotated about pivot 1406 using hydraulic arm 1404 in order to move wall panel 1008 from the horizontal position to a near vertical position. FIGS. 15-16 depict wall panel 1008 disposed nearly vertical on tilting table 1401.

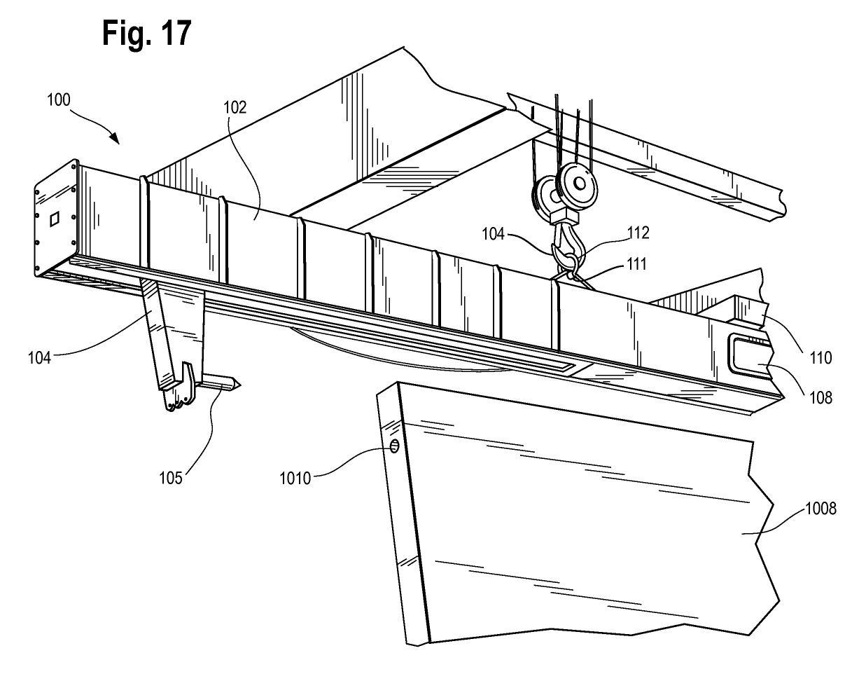

As depicted in FIG. 17, crane 1002 can be used to align pins 105, 107 of lifting beam assembly 100 with holes 1010, 1012 of wall panel 1008. Once aligned, Motorized drive mechanism 108 can be actuated to cause pins 105, 107 to move toward the center of beam 102 until pins 105, 107 engage holes 1010, 1012. Once engaged, crane 1002 and lifting beam assembly 100 can be used to transport wall panel 1008 in the vertical orientation.

In certain embodiments, operating the systems and/or applying the methods described herein can provide for improved transportation and storage of wall panels in a vertical orientation that were cast in a horizontal orientation.

While particular elements, embodiments and applications of the present invention have been shown and described, it will be understood that the invention is not limited thereto since modifications can be made by those skilled in the art without departing from the scope of the present disclosure, particularly in light of the foregoing teachings.

What is claimed is:

1. A lifting beam assembly comprising:
(a) a lifting beam;
(b) a pair of oppositely facing pin carriages mounted on said lifting beam, each of said pin carriages comprising a pin adapted to be received in a hole formed in opposing sides of a precast wall panel formed in a horizontal position; and
(c) a motorized drive mechanism configured to displace said pin carriages toward and away from each other along the length of said lifting beam.

2. The lifting beam assembly of claim 1, wherein the lifting beam is configured to be lifted by an overhead crane using a pair of hooks.

3. The lifting beam assembly of claim 1, wherein the motorized drive mechanism is operatively connected to a drive shaft that is operatively connected to a pair of ball screws, each ball screw associated with one of the pin carriages in order to displace the associated pin carriage.

4. The lifting beam assembly of claim 3, wherein rotation of the drive shaft in a first direction causes the pin carriages to move away from each other, and wherein rotation of the drive shaft in a second direction opposite the first direction causes the pin carriages to move toward each other.

5. The lifting beam assembly of claim 1, further comprising a load cell pin configured to detect a weight of the lifting beam assembly and any item affixed thereto.

6. The lifting beam assembly of claim 5, further comprising a scale display configured to display the weight detected by the load cell.

7. The lifting beam assembly of claim 1, wherein the pin carriages remain equidistant from a center of the lifting beam when the pin carriages are displaced.

8. A system for orienting to a vertical position a precast wall panel formed in a horizontal position, the panel having holes formed in opposite sides thereof, the system comprising:
(a) an overhead crane having a pair of suspended hooks;
(b) a lifting beam suspended from said crane hooks, said lifting beam comprising:
(i) a pair of oppositely facing pin carriages mounted on said lifting beam, each of said pin carriages comprising a pin adapted to be received in one of said panel holes;
(ii) a motorized drive mechanism for displacing said pin carriages toward and away from each other along the length of said lifting beam.

9. The system of claim 8, wherein the motorized drive mechanism is operatively connected to a drive shaft that is operatively connected to a pair of ball screws, each ball screw associated with one of the pin carriages in order to displace the associated pin carriage.

10. The system of claim 9, wherein rotation of the drive shaft in a first direction causes the pin carriages to move away from each other, and wherein rotation of the drive shaft in a second direction opposite the first direction causes the pin carriages to move toward each other.

11. The system of claim 8, further comprising a load cell pin configured to detect a weight of the lifting beam assembly and any item affixed thereto.

12. The system of claim 11, further comprising a scale display configured to display the weight detected by the load cell.

13. The system of claim 8, wherein the pin carriages remain equidistant from a center of the lifting beam when the pin carriages are displaced.

14. The system of claim 8, further comprising a vacuum lifting beam configured to use suction to lift a horizontally disposed wall panel.

15. A method of orienting to a vertical position a precast wall panel formed in a horizontal position comprising:
aligning pins extending from a pair of oppositely facing pin carriages on a lifting beam with holes formed in opposite sides of a precast wall panel formed in a horizontal position;
displacing the pin carriages toward each other along the length of said lifting beam such that said pins engage said holes; and
raising the lifting beam, thereby orienting said wall panel in a vertical position.

16. The method of claim 15, wherein hooks suspended from an overhead crane are used to align the pins and raise the lifting beam.

17. The method of claim 15, further comprising using a vacuum lifting beam to lift the wall panel in a horizontal orientation and place the wall panel on a tilting table in the horizontal orientation.

18. The method of claim 15, further comprising using the tilting table to rotate the wall panel from the horizontal orientation to a near vertical orientation.

19. The method of claim 15, further comprising placing the vertically oriented wall panel in a trailer configured to transport vertically oriented wall panels.

20. The method of claim 15, further comprising continuously measuring and displaying a weight of the lifting beam and the wall panel.
